(19) United States
(12) Patent Application Publication
(10) Pub. No.: US 2010/0165397 A1
(43) Pub. Date: Jul. 1, 2010

(54) Information Processing Device and Recording Medium Containing Program Therefor

(75) Inventor: Kazutaka YAMADA, Nagakute-cho (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi (JP)

(21) Appl. No.: 12/647,197

(22) Filed: Dec. 24, 2009

(30) Foreign Application Priority Data
Dec. 25, 2008 (JP) 2008-330105

(51) Int. Cl. G06F 15/00

(52) U.S. Cl. 358/1.15

(57) ABSTRACT

An information processing device is provided with a display controller configured to display a data display window on a screen of a display device. At least one decision area is defined within the display screen. A storage stores, in association with the at least one decision area printer selection information identifying a printer and/or print setting information. The information processing device further includes a control unit configured to identify a printer to be used based on the printer selection information corresponding to the at least one decision area and/or print setting based on the print setting information if the judging unit judges a dropped position of a data file is within the at least one decision area, print data being generated in accordance with the printer and/or print setting identified by the control unit.

### CROSS-REFERENCE TO RELATED APPLICATION

This application claims priority under 35 U.S.C. §119 from Japanese Patent Application No. 2008-330105 filed on Dec. 25, 2008. The entire subject matter of the application is incorporated herein by reference.

### BACKGROUND

1. Technical Field

Aspects of the present invention relate to an information processing device and a recording medium containing a program to be executed by a PC (personal computer) or the like.

2. Related Art

Conventionally, there has been known an information processing device configured to display, on a screen of a display device, thumbnails corresponding to printable data files and one or more printer icons respectively corresponding to one or more printers which are connected to the information processing device.

When a user of such a conventional information processing device intends to print one of the data files, the user drags one of the thumbnail displayed on the screen and drops the data file onto a printer icon representing the printer the user intends to use, using a pointing device such as a mouse. When the thumbnail is dropped on the printer icon, a list of a plurality of predetermined print settings for the printer corresponding to the printer icon on which the thumbnail is dropped is displayed. When the user further drags and drops the thumbnail on a desired print setting within the list of the plurality of print settings, the printer and the print setting displayed at a place where the thumbnail is dropped is selected.

### SUMMARY

In the above-described configuration of the conventional information processing device, there remain problems. Namely, since a plurality of printer icons and thumbnails corresponding to data files are displayed on the screen, it becomes difficult to for a user to quickly identify a desired printer icon among the plurality of printer icons, and an efficiency of a print operation may be lowered.

According to aspects of the invention, there is provided an information processing device to which one or more printers are connected. The information processing device is provided with a display device having a display screen, a display controller configured to display a data display window on the display screen, printable data files being displayed on the display screen and/or inside the data display window, at least one decision area defined within the display screen, a user interface acquiring a drag and drop operation to any one of the printable data files, a dropped position detecting unit configured to detect a drop position of the printable data file to which the drag and drop operation is applied, a storage configured to store, in association with the at least one decision area, printer selection information identifying one of the connected printers to be used for printing and/or print setting information representing print settings to be used for printing, a judging unit configured to judge whether the dropped position is within the at least one decision area. The information processing device further includes a control unit configured to identify printer to be used for executing print operation based on the printer selection information corresponding to the at least one decision area and/or print setting to be used for executing the print operation based on the print setting information if the judging unit judges the dropped position is within the at least one decision area, print data being generated in accordance with the printer and/or print setting identified by the control unit.

According to further aspects of the invention, there is provided a computer accessible recording medium containing a program executable by a computer, the program causing, when executed, the computer to operate as an information processing device, the computer being provided with a display device having a display screen and connected with one or more printers. Such an information processing device includes a display controller configured to display a data display window on the display screen, printable data files being displayed on the display screen and/or inside the data display window, at least one decision area defined within the display screen, a user interface acquiring a drag and drop operation to any one of the printable data files, a dropped position detecting unit configured to detect a drop position of the printable data file to which the drag and drop operation is applied, a storage configured to store, in association with the at least one decision area, printer selection information identifying one of the connected printers to be used for printing and/or print setting information representing print settings to be used for printing, and a judging unit configured to judge whether the dropped position is within the at least one decision area. Further, there is provided a control unit configured to identify printer to be used for executing print operation based on the printer selection information corresponding to the at least one decision area and/or print setting to be used for executing the print operation based on the print setting information if the judging unit judges the dropped position is within the at least one decision area, print data being generated in accordance with the printer and/or print setting identified by the control unit.

According to further aspects of the invention, there is provided a method of controlling an information processing device to which one or more printers are connected, the information processing device including a display device having a display screen. The method includes the steps of displaying a data display window on the display screen, printable data files being displayed on the display screen and/or inside the data display window, defining at least one decision area within the display screen, acquiring a drag and drop operation to any one of the printable data files, detecting unit configured to detect a drop position of the printable data file to which the drag and drop operation is applied, storing, in association with the at least one decision area, printer selection information identifying one of the connected printers to be used for printing and/or print setting information representing print settings to be used for printing, judging whether the dropped position is within the at least one decision area, and identifying printer to be used for executing print operation based on the printer selection information corresponding to the at least one decision area and/or print setting to be used for executing the print operation based on the print setting information if the judging unit judges the dropped position is within the at least one decision area print data being generated in accordance with the printer and/or print setting identified by the control unit.

### BRIEF DESCRIPTION OF THE ACCOMPANYING DRAWINGS

FIG. 1 is a block diagram schematically illustrating a configuration of personal computer (PC) according to aspects of the invention.

FIG. 2 shows a display screen and display window displayed on the display device of the PC according to aspects of the invention.

FIGS. 3 and 4 show a flowchart illustrating a print process executed by a CPU of the PC in response to a drag and drop operation, according to aspects of the invention.

FIG. 5 shows an example of an assignment user interface window displayed on the display device of the PC according to aspects of the invention.

FIG. 6 shows a first frame-shaped area and a second frame-shaped area defined on the display screen and the display window, which are displayed on the display device of the PC according to the aspects of the invention.

FIG. 7 shows an example of the drag and drop operation for dropping a data file onto an upper edge of the display window, which is displayed on the display device of the PC according to aspects of the invention.

FIG. 8 shows an example of a filer designating window displayed on the display device of the PC according to aspects of the invention.

FIG. 9 is an example of a print execution confirmation dialogue displayed on the display device of the PC according to aspects of the invention.

### DETAILED DESCRIPTION

Hereinafter, an exemplary embodiment according to aspects of the present invention will be described with reference to the accompany drawings.

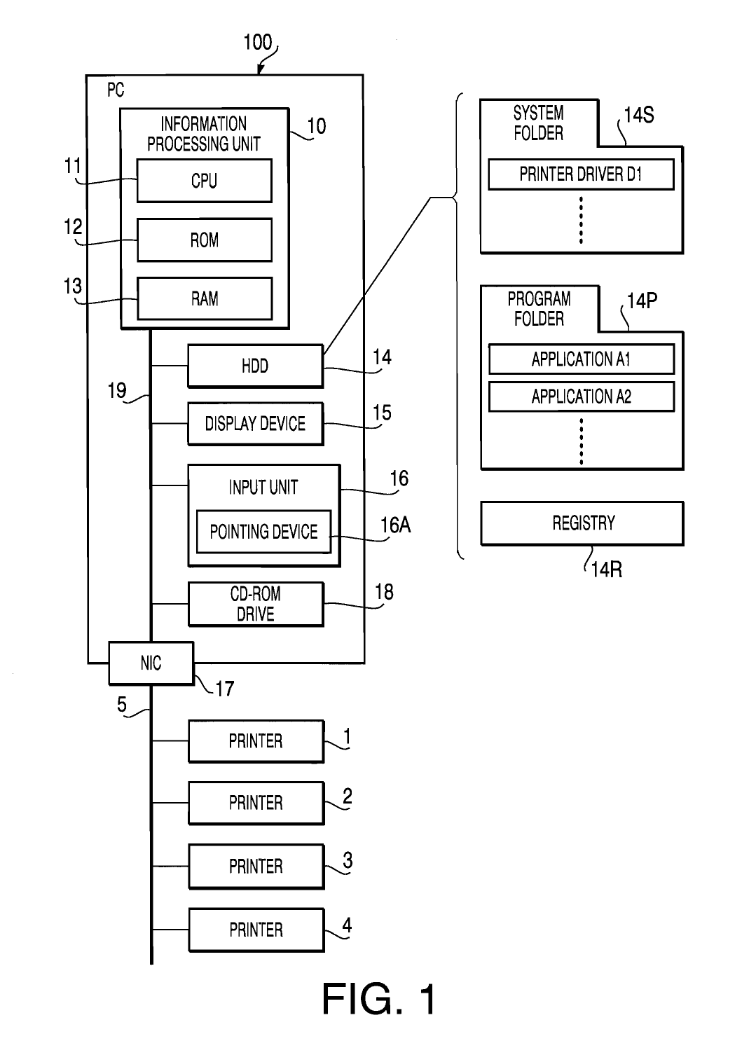

As shown in FIG. 1, a personal computer (hereinafter, the personal computer will be referred to as “PC”) 100, which is an exemplary embodiment according to aspects of the present invention, includes an information processing unit 10, an HDD (Hard Disc Drive) 14, a display device 15, an input unit 16, an NEC (Network Interface Card) 17 for connecting the PC 100 to a network 5, and a CD-ROM drive 18, which are interconnected via an internal bus 19 so as to communicate with each other. It should be noted that, the information processing device needs not be limited to the PC 100, but can be any other information processing device such as PDA (Personal Digital Assistance) terminals.

The PC 100 and printers 1-4 are connected to the network 5 such as LAN (Local Area Network) as peripheral devices, and constitute a network system. Each of the printers 1-4 is capable of printing an image and/or a document on a sheet based on graphical data and/or text data transmitted from the PC 100 via the network 5.

According to the exemplary embodiment, one or more printers can be connected to the PC 100 through the network 5. In the following description, it is assumed that four printers 1-4 are connected to the PC 100. Each of the printers 1-4 may be directly connected to the PC 100 with a serial cable or a USB (Universal Serial Bus) cable instead of the connection through the network 5.

The information processing unit 10 is provided with a CPU 11, a ROM 12, a RAM 13, which are mounted on a substrate to constitute a so-called mother board and controls each component provided in the PC 100.

In the PC 100, an operating system (OS) is installed, and various types of software run under the environment of the OS. In the following description, it is assumed that Windows (registered trademark) is installed in the PC 100 as the OS. It should be noted that the OS needs not be limited to the “Windows OS,” and the aspects of the invention can also be applied to the information processing device employing another OS.

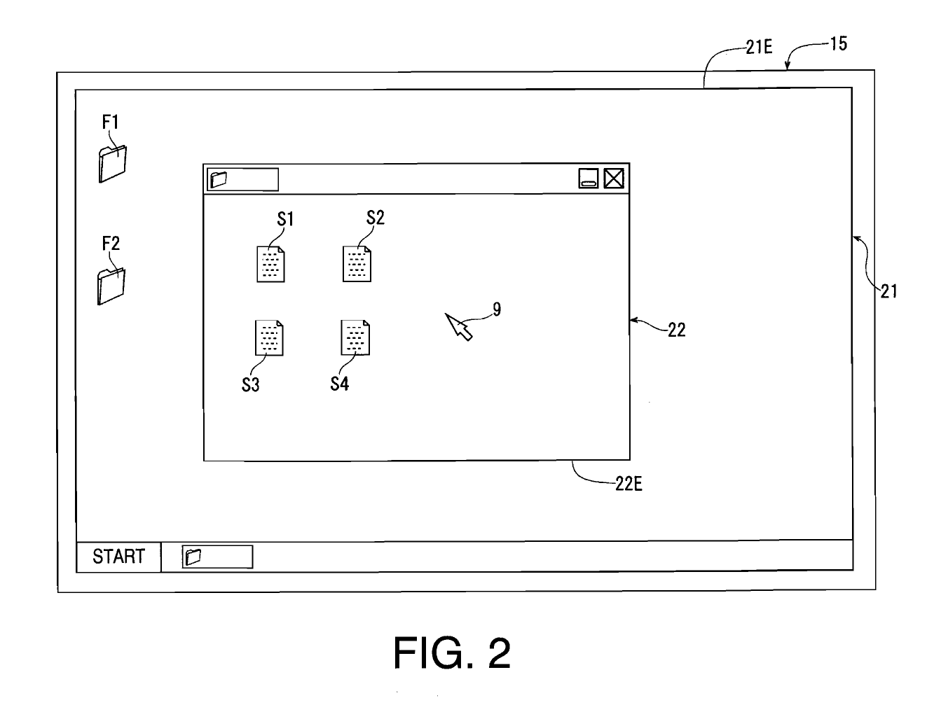

The display device 15 is, for example, an LCD (Liquid Cristal Display), which is connected to the information processing unit 10 via a video board or a graphic board (not shown in FIG. 1). As shown in FIG. 2, the display 15 typically has a rectangular display screen 21. On the screen 21, data files, folders and/or results of various data processes executed by the information processing unit 10 are displayed.

As shown in FIG. 1, the input unit 16 is a user interface typically provided with a keyboard and a pointing device 16A such as a mouse. The input unit 16 is connected to the information processing unit 10 through, for example, a USB terminal or a PS/2 terminal (not shown in FIG. 2). Various pieces of information are input to the information processing unit 10 in accordance with user operations of the input unit 16.

The HDD 14 is configured with a high volume disk and a reading device for reading the high volume disk, which are integrated as a single unit. The HDD 14 stores a system folder 14S and a program folder 14P and a registry 14R.

The system folder 14S contains various system files which are necessary for the operations of the OS and a printer driver D1 which is a kind of a device driver.

The program folder 14P contains programs of various kinds of applications (e.g., applications A1, A2, . . . ). The registry 14R contains device information representing the correspondence between the data files, which are stored in the system folder 14S and/or the program folder 14P, and devices is registered. For example, the device information may include reference addresses of the data files which are referred to by the respective devices.

The HDD 14 stores folders which are hierarchically organized. A unique address is assigned to each of the folders in which various data files are stored. As shown in FIG. 2, folder icons (e.g., folder icons F1, F2) corresponding to particular folders are displayed on the display screen 21. For example, if the user operates the pointing device 16A to double-click the folder icon F1, a display window 22 corresponding to the folder icon F1 is displayed on the screen 21. In the display window 22, various data files (e.g., data files S1-S4) stored in the folder corresponding to the folder icon F1 are displayed as thumbnails (reduced images). Such a function of the display window 22 is realized by means of a well-known file manager (hereinafter, the file manager is referred as “filer”) which is one of the utilities of the OS.

As shown in FIG. 1, the applications A1 and A2 are programs for performing particular information processing (e.g., word processing, calculation processing) using the information processing unit 10, the HDD 14, the display 15 and the input unit 16 under the environment of the OS. In the exemplary embodiment, it is assumed that the data files S1-S4, which are printable files, are stored in the folder corresponding to the folder icon F1. The data files S1-S4 are generated as a result of information processing executed by the applications A1 and A2, which are displayed as thumbnails within the display window 22.

As shown in FIG. 2, an arrow-shaped mouse pointer 9 is superimposed on the display screen 21. The user can move, by operating the pointing device 16A, the mouse pointer 9 freely to an arbitrary point on the display screen 21 and the display window 22. Thus, by a well-known drag and drop operation using the pointing device 16A, the user can move any one of the data files S1-S4 and the folder icons F1 and F2 to an arbitrary point on the display screen 21 and the display window 22.

The printer driver D1 is software to make the printer 1-4 execute a print operation. Usually, when the user intends to print out one of the data files S1-S4, a print command is generated by a right click with mouse pointer 9 located on one of thumbnails corresponding to the data files S1-S4, or by calling one of the data files S1-S4 after launching the application A1 or A2 corresponding to the one of the data files S1-S4. Then, the printer driver D1 displays a well-known print setting user interface window (not shown) to set printer selection information and print setting information on the display screen 21. The printer selection information and the print setting information are set by the user operation through the input unit 16.

The printer selection information is for identifying a printer, which is to be used to execute a print operation, among the printers 1-4 connected to the PC 100. The print setting information is information including a plurality of setting items and parameters to be selected for each setting item. For example, the print setting information may include a setting item of “sheet size” and parameters “A4, 84, A3,” a setting item of “sheet type” and parameters “plain paper, gloss paper,” and a setting item of “resolution” and parameters of “1200 dpi, 800 dpi” and the like.

According to the print setting information, the printer driver D1 makes the information processing unit 10 generate print data based on the data files S1-S4. Then, the printer driver D1 transmits the generated print data to a selected printer (one of the printers 1-4), which is identified by the printer selection information, through the NIC 17 and makes the printer execute a print operation.

Alternatively, the printer driver D1 may not generate the print data, and the printer driver D1 may transmit the print data to the printer (one of the printers 1-4), which is identified by the printer selection information, through the NIC 17, and makes the printer generate the print data and print out the same.

The installation of applications A1, A2 and printer driver D1 is performed by reading data from the CD-ROM in which the programs for the applications A1, A2 and printer driver D1 are stored, using the CD-ROM drive 18, and storing the retrieved data into the HDD 14 after various settings are made by the information processing unit 10.

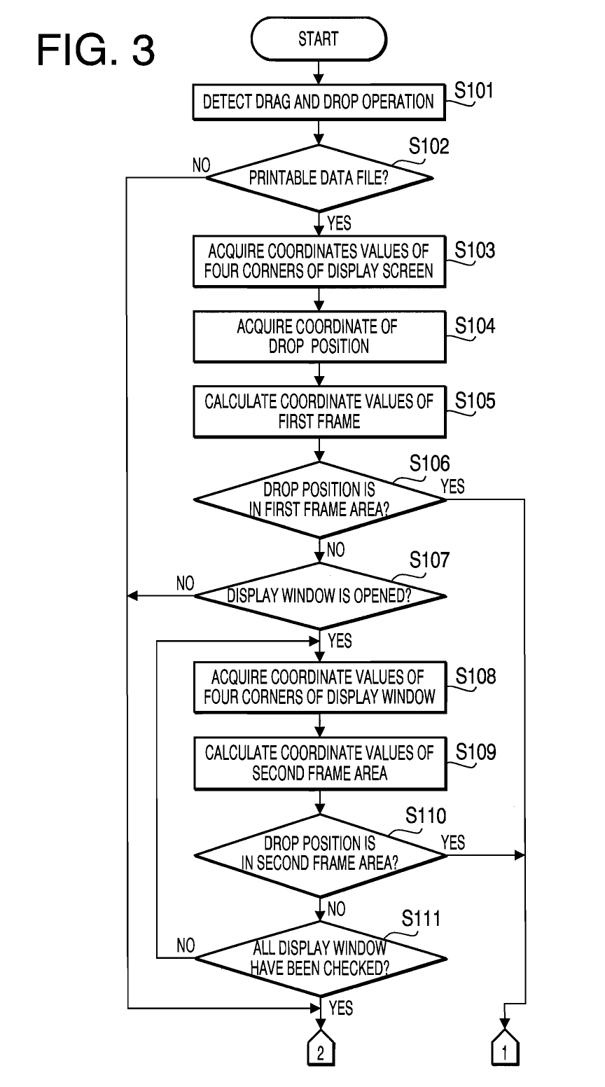

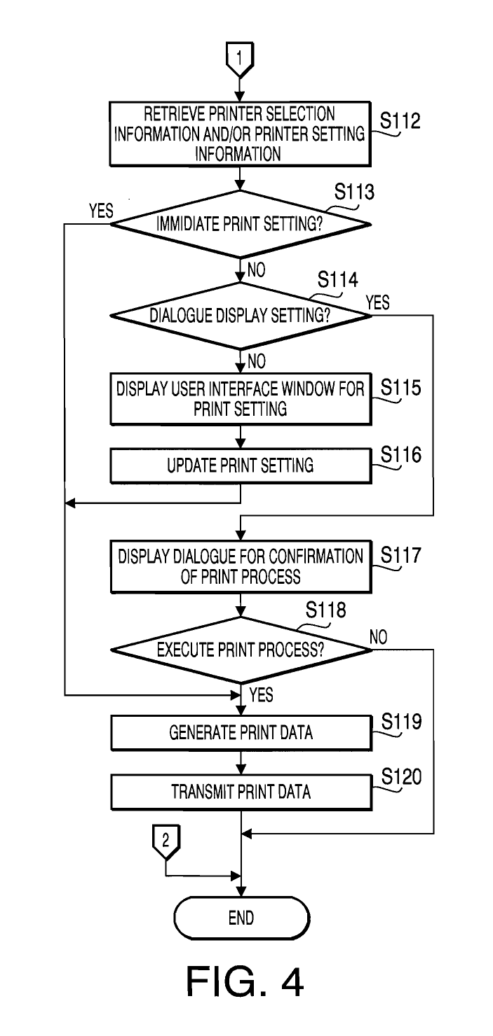

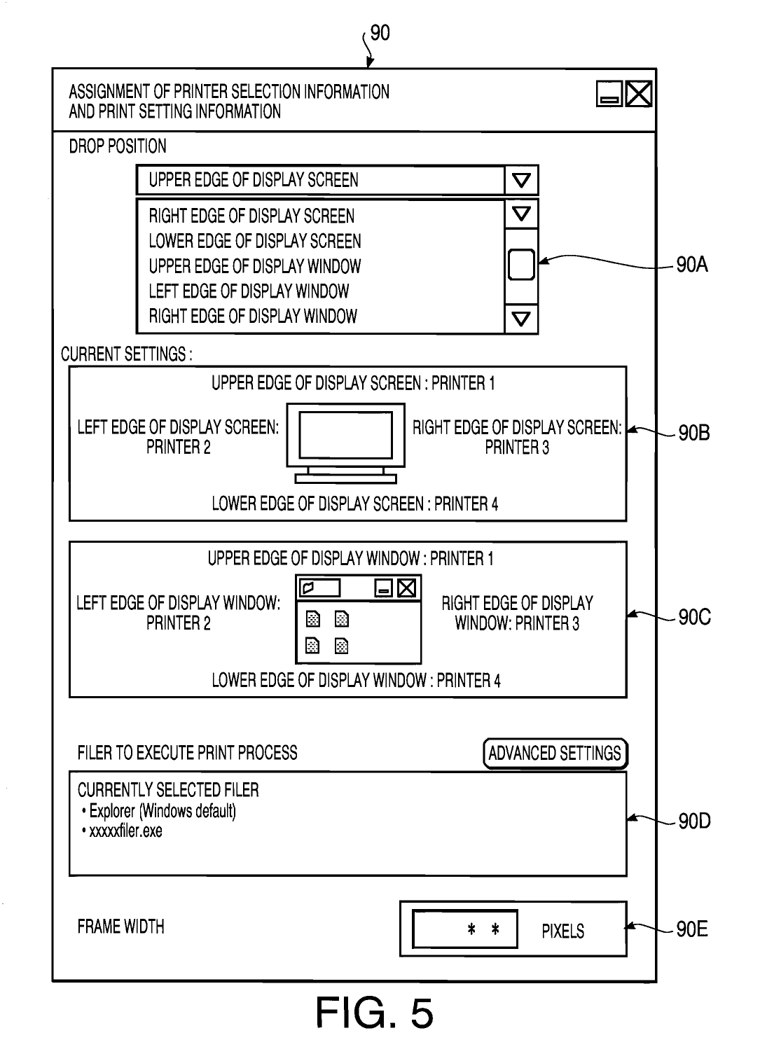

In the PC 100 described above, the printer driver D1 includes a program which makes the information processing unit 10 execute a “printing process” corresponding to the drag and drop operation, which is shown in FIGS. 3 and 4. Further, the information processing unit 10 and the printer driver D1 cause the display device 15 to display a user interface window for “the assignment of the printer selection information and the print information to each side of the display screen and the display window” (hereinafter, referred to as “assignment user interface window”) 90 on the screen 21 as shown in FIG. 5. In response to a user operation through the “assignment user interface window” 90, the information processing unit 10 and the printer driver D1 define a first frame area 21F, which is a decision area, on the screen 21, and a second frame area 22F, which is another decision area, on the display window 22, as shown in FIG. 6.

According to the information processing unit 10 and the printer driver D1, the user can print an arbitrary data file with a desired print setting using an identified printer (one of printers 1-4) simply by dragging and dropping the thumbnails of the printable data files S1-S4 displayed on the display window 22 onto the first frame area 21F of the display screen 21 or the second frame area 22F of the display window 22.

Next, the first frame area 21F and the second frame area 22F will be described referring to FIG. 6. On the display screen 21, a frame-shaped area is defined by an outer edge 21E and an inner edge 21G. The outer edge 21E has a rectangle shape defined by a first point P11 at an upper left corner point P11, a second point P12 at the upper right corner, a third point P13 at the lower left corner and a fourth point P14 at the lower right corner of the outer edge 21E. Based on a resolution ((the number of horizontal pixels W1)×(the number of vertical pixels H1)) of the display screen 21, each of the first to fourth points P11-P14 is expressed as P11 (0, 0), P12 (W1, 0), P13 (0, H1) and P14 (W1, H1). In practice, for example, the resolution of the display screen 21 is set to “1,024×768 pixels,” “1,900×1,200 pixels,” or the like. When the resolutions of display screens 21 are different, the coordinate values of the first to the fourth points P11-P14 are different. The inner edge 21G is defined by four points P21 (M, N), P22 (W1, 0), P23 (W, N+H2) and is spaced from the outer edge 21E by a predetermined width T toward the center of the display screen 21.

The first frame area 21F is divided into four divided areas 21A, 21B, 21C and 21D. The divided area 21A extends along an upper edge portion of the first frame area 21F and has a trapezoid shape defined by four points: the first point P11 (0, 0), the second point P12 (W1, 0), a fifth point P15 (T, T) and a sixth point P16 (W1−T, T). The divided area 21B extends along a left edge portion of the first frame area 21F and has a trapezoid shape defined by four points: the first point P11 (0, 0), the third point P13 (0, H1), the fifth point P15 (T, T) and a seventh point P17 (T, H1−T). The divided area 21C extends along a right edge portion of the first frame area 21F and has a trapezoid shape defined by four points: the second point P12 (W1, 0), the fourth point P14 (W1, H1), the sixth point P16 (W1−T, T) and an eighth point P18 (W1−T, H1−T). The divided area 21D extends along a lower edge portion of the first frame area 21F and has a trapezoid shape defined by four points: the third point P13 (0, H1), the fourth point P14 (W1, H1), the seventh point P17 (T, H1−T) and the eighth point P18 (W1−T, H1−T).

The display window 22 is defined by an outer edge 22E and an inner edge 22G. The outer edge 22E has a rectangle shape defined by a first point P21 at the upper left corner of the outer edge 22E, a second point P22 at the upper right corner of the outer edge 22E, a third point P23 at the lower left corner of the outer edge 22E and a fourth point P24 at the lower right corner of the outer edge 22E. Based on a resolution ((the number of horizontal pixels W1)×(the number of vertical pixels H1)), a position (M, N) and a size (W2×H2) of the display window 22, the coordinate values of each of the first to fourth points P21-P24 is respectively defined as: the first point P21 (M, N), the second point P22 (M+W2, N), the third point P23 (M, N+H2) and the fourth point P14 (M+W2, N+H2). Note that, the position (M, N) and the size (W2×H2) may be changed appropriately by the user operation or an automatic adjustment function of the filer.

The second frame area 22F, which is another decision area, has a rectangular frame-shaped area defined by the outer edge 22E of the display window 22 and the inner edge 22G which is inwardly spaced from the outer edge 22E by a predetermined width T. The second frame area 22F is divided into four divided areas 22A, 22B, 22C and 22D. The divided area 22A extends along an upper edge portion of the first frame area 22F and has a trapezoid shape defined by four points: the first point P21 (M, N), the second point P22 (M+W2, N), a fifth point P25 (M+T, N+T) and a sixth point P26 (M+W2−T, N+T). The divided area 22B is assigned at a left edge portion of the first frame area 22F and is in a trapezoid shape sectioned by four points of the first point P21 (M, N), the third point P23 (M, N+H2), the fifth point P25 (M+T, N+T) and a seventh point P27 (M+T, N+H2−T). The divided area 22C extends along a left edge portion of the first frame area 22F and has a trapezoid shape defined by four points: the second point P22 (M+W2, N), the fourth point P24 (M+W2, N+H2), the sixth point P26 (M+W2−T, N+T) and a eighth point P28 (M+W2−T, N+H2−T). The divided area 22D extends along a lower edge portion of the first frame area 22F and has a trapezoid shape defined by four points: the third point P23 (M, N+H1), the fourth point P24 (M+W2, N+H2), the seventh point P27 (M+T, N+H2−T) and the eighth point P28 (M+W2−T, N+H2−T).

The coordinate information (i.e., coordinate values) of the first frame area 21F and the second frame 22F is usually stored in the registry 14R. It should be noted that the above-described division definition of the first frame area 21F and the second frame area 22F described above is merely an example and the number of the divided areas may be changed and/or the border of the divided areas may be arbitrarily changed. The coordinate information is not necessarily be stored in the registry 14R, and may be stored in a configuration file such as an INI file, alternatively or optionally.

Next, referring to FIG. 5, the assignment user interface window 90 will be described. The user can associate the printer selection information and/or the print setting information with each of sides of the display screen 21 and the display window 22. Such an association configuration is also stored in the registry 14R as needed.

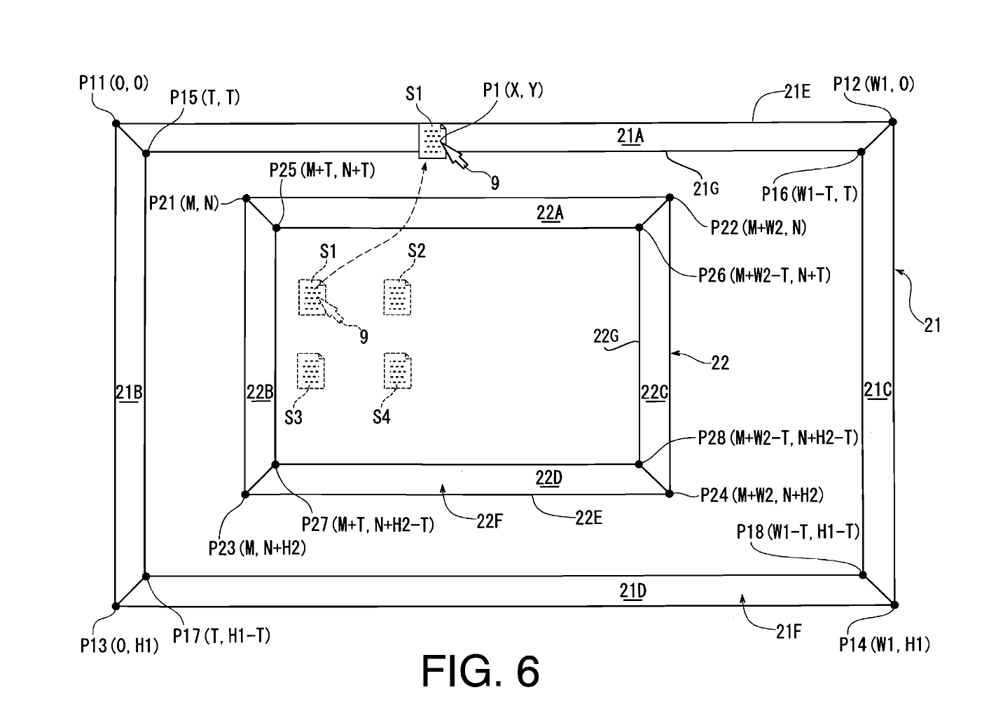

The user may select one area among the divided areas 21A-21D and 22A-22D by designating one of the sides of the display screen 21 or the display window 22 using a “DROP POSITION” designation filed 90A of the assignment user interface window 90. For example, when the user designates “UPPER EDGE OF DISPLAY SCREEN,” the divided area 21A is identified (i.e., selected), and then “SETTING FOR UPPER EDGE OF DISPLAY SCREEN” window 91 shown in FIG. 7 is displayed on the display screen 21. As the user inputs parameters in a “PRINTER SELECTION” field 91A and/or a “PRINT SETTING” field 91B, printer selection information and/or print configuration information associated with the divided area 21A is stored to the registry 14R. Through a “DIALOGUE DISPLAY BEFORE PRINT PROCESS” field, the user can choose a dialog display condition form among processes of “EXECUTE PRINT PROCESS WITHOUT DIALOGUE DISPLAY,” “DISPLAY DIALOGUE FOR CONFIRMATION OF PRINT PROCESS” or “DISPLAY USER INTERFACE WINDOW FOR PRINT SETTING.” As described above, the user can assign an operation condition of the printer driver D1 if the data file is dropped onto the upper edge portion of the display screen 21 in advance.

It should be noted that, in the “DROP POSITION” field 90A, when another area is selected among the divide areas 21B-21D and 22A-22D is selected, a window similar to the “SETTING FOR UPPER EDGE OF DISPLAY SCREEN” window 91 is displayed and the user can assign the operation condition of the printer driver in a similar manner.

In the “CURRENT SETTINGS” fields 9013 and 90C of the assignment user interface window 90, the printer selection information and/or print setting information currently associated with respective edges of the display window 21 and display window 22 is displayed. According to the embodiment, it is assumed that the printers 1-4 are located on front, left, right and back sides with respect to the display 15. As shown in FIG. 5, the printers 1-4 are associated with the upper edge, left edge, right edge and lower edge of each of the display windows 21 and 22. Thus, the association of the printers 1-4 with the edges of the display windows 21 and 22 corresponds to the positional relationship of between the user sitting in front of the display 15 and each of the printers 1-4. It should be noted that the above configuration shown in FIG. 5 is merely an exemplary one and various types of association may be made. For example, four different pieces of setting information for one printer may be assigned to four edges of the display window 21 or 22, respectively.

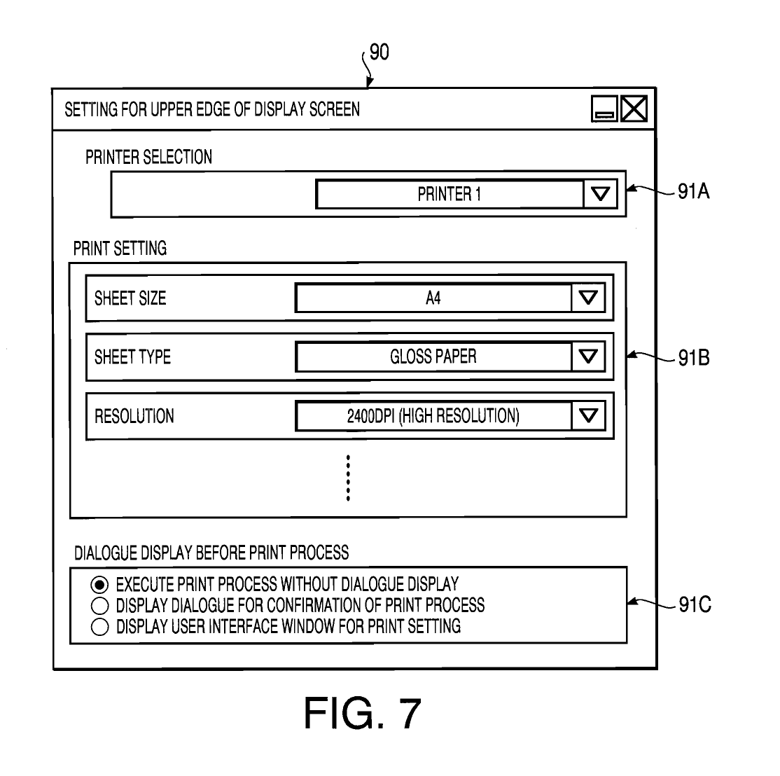

In a “FILER TO EXECUTE PRINT PROCESS” field 90D of the assignment user interface window 90, the currently selected filer is displayed. If the user clicks an “ADVANCED SETTINGS” button at an upper right of the display field 90D, a “FILER DESIGNATION” window 92 shown in FIG. 8 is displayed in the display window 21. The user can designate a default filer implemented in the OS as the filer for executing the print operation when the drag and drop operation is executed through the window 92. Alternatively, the user may designate a desired filer instead of the default filer. Further, through the window 92, the user can register a plurality of filers in a filer list and/or delete a filer from the filer list.

In the “FRAME WIDTH” field 90E of the assignment user interface window 90 (see FIG. 8), the widths of the first and second frame-shaped areas 21F and 22F are displayed. By entering desired values in the field 90E, the user can change the width T of the frame-shaped areas 21F and 22F. In the exemplary embodiment, the first and second frame-shaped areas 21F and 22F has the same width T, for brevity. However, in practice, it may be possible that different widths are set for the frame-shaped areas 21F and 22F. It is also possible to modify the embodiment such that each divided area of the frame-shaped area 21F or 22F may be set to have different widths.

Next, referring to FIGS. 3 and 4, a print process corresponding to the drag and drop operation will be described.

The print process shown in FIGS. 3 and 4 is executed by the CPU of the information processing unit 10 under the environment of the OS.

In S101, the CPU detects if a data file (e.g., one of the data files S1-S4) displayed in the display screen 21 or display window 22 is dragged with the pointing device 16A and dropped on the frame-shaped area 21F or 22F. When the drag and drop operation is detected, the CPU proceeds to S102.

In S102, the CPU judges whether the dropped data file is a printable file. If the dropped file is not printable (S102: NO), the print process is once terminated. Then, the print process reexecuted, and the CPU monitors the drag and drop operation in S101.

If the dropped file is printable (S102: YES), the CPU proceeds to S103. For example, if the user drags and drops the data file S1 on the frame-shaped area 21E as shown in FIG. 6, the CPU executes S103.

In S103, the CPU acquires the coordinates of the first to fourth points P11-P14 for the registry 14R as the coordinate information of the outer edge portion 21E of the display screen 21.

In S104, the CPU detects a position P1 (X, Y) of the display screen 21 on which the data file is dropped. According to the embodiment, the CPU detects the coordinates of the tip of the mouse pointer 9 overlaid on the dropped data file (see FIG. 6). It should be noted that the dropped position P1 may vary within a trapezoidal area defined by the first to fourth points P11-P14.

In S105, the CPU calculates the coordinate values of the fifth to eighth points P15-P18 that define the divided areas 21A, 21B, 21C and 21D together with the first to fourth points P11-P14. It should be noted that the coordinate values of the fifth to eighth points P15-P18 may be calculated in advance when the width T is determined and stored in the registry 14R. In such a case, the CPU merely retrieves the stored values from the registry 14R.

In S106, the CPU compares the coordinate values of the dropped position P1 with the coordinate information of the divided areas 21A-21D, and judges whether the dropped position P1 is included in one of the divided areas 21A-21D.

If the dropped position P1 is included in one of the divided areas 21A-21D (S106: YES), the CPU proceeds to S112 (see FIG. 4). That is, as shown in FIG. 6, if the dropped position P1 of the data file S1 is included in the divided area 21A, the CPU proceeds to S112. Otherwise (S106: NO), the CPU proceeds to S107.

In S107, the CPU judges whether the display window which is assigned to execute the drag and drop printing process is displayed on the display screen 21. If not (S107: NO), the print process is terminated. Then, the print process is reexecuted and the CPU monitors the occurrence of the drag and drop operation in SI01. If yes (S107: YES), the CPU proceeds to S108. According to the embodiment, it is assumed that the display window 22, which is displayed on the display screen 21 is assigned to execute the drag and drop printing process.

In S108, the CPU acquires the coordinate values of the first to fourth points P21-P24 as the coordinate information of the outer edge portion 22E of the display window 22 (see FIG. 6) from the registry 14R.

Next, the CPU proceeds to S109 and calculates the coordinate values of the fifth to eighth points P25-P28 for identifying the divided areas 22A-22D as the coordinate information of the second frame-shaped area 22F based on the coordinate information of the outer edge portion 22E of the display window 22 and the width T of the second frame-shaped area 22F.

Next, in S110, the CPU compares the coordinates information of the dropped position P1 with the coordinate information of the divided areas 22A, 22B, 22C and 22D to determined whether the dropped point P1 is included in one of the divided areas 22A-22D.

If the dropped point P1 is included in one of the divided areas 22A-22D (S110: YES), the CPU proceeds to S112 (see FIG. 4). If not (S110: NO), the CPU proceeds to S111, at which the CPU judges whether the steps S108-S111 have been executed for all the display windows displayed on the display screen 21.

If judgment at S111 is NO, the CPU returns to S108, and repeatedly executes S108-S110 for each of the display windows. If judgment in S111 is YES, the process is terminated. Then, the CPU reexecutes the print process and monitors the occurrence of the drag and drop operation in S101.

When the CPU proceeds, from S106 or S110, to S112 (FIG. 4), the CPU retrieves the printer selection information and/or print setting information associated with the divided area including the dropped position P1 from the registry 14R. For example, if the dropped position P1 is included in the divided area 21A as shown in FIG. 6, the print setting window 91 as shown in FIG. 7 is displayed. In this example, the printer 1 is selected, and the print settings include the sheet size of “A4,” the sheet type of “GLOSS PAPER” and the like.

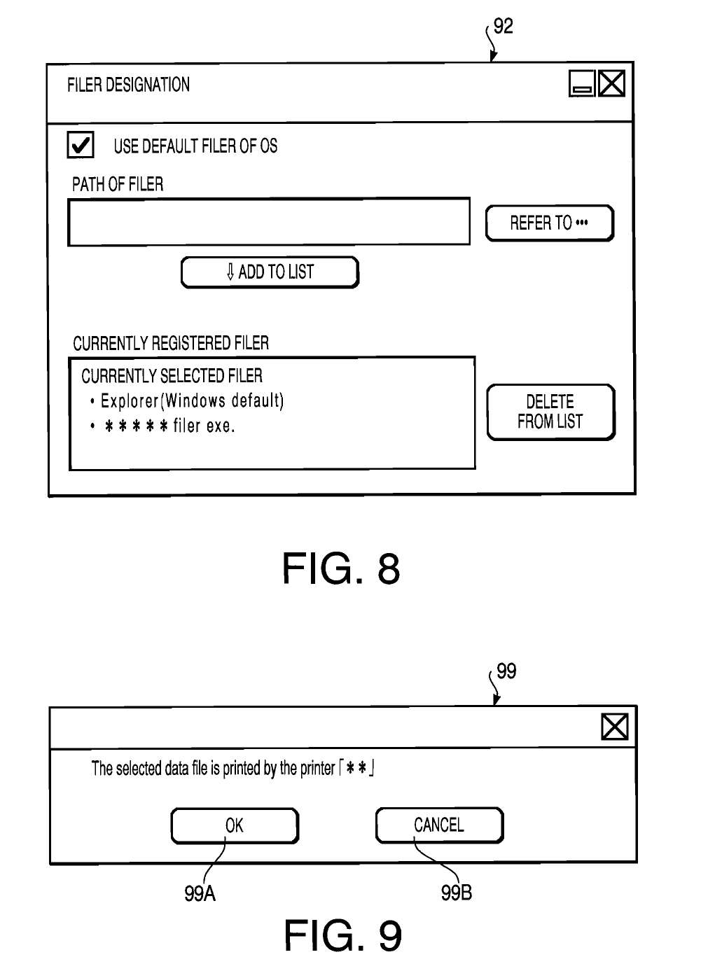

Next, the CPU proceeds to S113 where the CPU judges whether the field 91C is set to “EXECUTE PRINT PROCESS WITHOUT DIALOGUE DISPLAY.” If the judgment in S113 is NO, the CPU proceeds to S114 and judges whether the field 91C is set to “DISPLAY DIALOGUE FOR CONFIRMATION OF PRINT PROCESS.” If the judgment in S114 is YES, the CPU proceeds to S117 and displays the dialogue 99 shown in FIG. 9 on the display screen 21. In this example, the dialogue 99 includes a message inquiring the user whether the print operation of the selected data file with the printer identified by the printer selection information, an “OK” button 99A for executing the print operation and a “CANCEL” button 99B for cancelling the print operation.

If the user did not select to execute the print operation (S118: NO), the process is terminated. Thereafter, the CPU reexecutes the print process and monitor the occurrence of the drag and drop operation in S101. If the user selected to execute the print operation (S118: YES), the CPU proceeds to S119.

If judgment in S114 is NO, the CPU proceeds to S115 where the field 91C is set that the print setting user interface window is displayed on the display screen 21. Such a print setting user interface is of a well-known one, description thereof is omitted for brevity.

Next, the CPU proceeds to S116. If the user operates the input unit 16 to change the settings through the user interface window, the CPU reflects the changed settings in the print setting information. Then, the CPU proceeds to S119.

When the CPU proceeds, from S113, S116 or S118, to S119, the CPU generates print data for printing the data file based on the selected print setting information. Since creation of the print data based on the data file that is generated by an application is well-known, detailed explanation thereof will not be provided for brevity.

Next, the CPU proceeds to S120 where the CPU transmits the generated print data to the printer identified by the printer selection information through the NIC 17. Then, the printer that received the print data prints out the data file which the user applied the drag and drop operation. After transmitting the print data, the process is terminated. Thereafter, the CPU reexecutes the print process and monitors the occurrence of the drag and drop operation in S101.

It should be noted that conversion of the data contained in the data file to the print data may be executed in the printer 1 (2, 3 or 4). In such a case, the CPU transmits the data file and print settings included in the print setting information to the designated printer in S120.

It should be noted that the present invention needs not be limited to the configuration described above. Various modifications of the embodiment may be made without departing from the scope of the invention.

What is claimed is:

1. An information processing device to which one or more printers are connected, comprising:
a display device having a display screen;
a display controller configured to display a data display window on the display screen, printable data files being displayed on the display screen and/or inside the data display window;
at least one decision area defined within the display screen;
a user interface acquiring a drag and drop operation to any one of the printable data files;
a dropped position detecting unit configured to detect a drop position of the printable data file to which the drag and drop operation is applied;
a storage configured to store, in association with the at least one decision area, printer selection information identifying one of the connected printers to be used for printing and/or print setting information representing print settings to be used for printing;
a judging unit configured to judge whether the dropped position is within the at least one decision area;
a control unit configured to identify a printer to be used for executing print operation based on the printer selection information corresponding to the at least one decision area and/or print setting to be used for executing the print operation based on the print setting information if the judging unit judges the dropped position is within the at least one decision area, print data being generated in accordance with the printer and/or print setting identified by the control unit.

2. The information processing device according to claim 1,
wherein the at least one decision area includes at least one of:
a first frame-shaped decision area including outer edge portions of the display screen and having a first predetermined width; and
a second frame-shaped decision area including outer edge portions of the display window and having a second predetermined width.

3. The information processing device according to claim 1,
wherein the at least one decision area is divided into a plurality of sub areas, and
wherein the storage stores the printer selection information and/or print setting information associated with each of the plurality of sub areas.

4. The information processing device according to claim 3,
wherein the at least one decision area includes an area defined by a first rectangle having upper, lower, right and left sides and a second rectangle having upper, lower, right and left sides which are spaced from those of the first rectangle by predetermined distances, respectively.

5. The information processing device according to claim 3,
wherein the at least one decision area is divided into four areas which are arranged as upper, lower, right and left portions of the at least one decision area.

6. The information processing device according to claim 1,
wherein the control unit includes a first setting system configured to set a width of the at least one decision area in accordance with a user input.

7. The information processing device according to claim 1,
wherein the control unit includes a second setting system configured to set, in accordance with a user input, whether print operation is executed immediately when the control unit identified the printer and/or print setting.

8. The information processing device according to claim 1,
wherein the control unit includes a third setting system configured to set, in accordance with a user input, whether a user interface window for acquiring the print settings is displayed before print operation is executed when the control unit identified the printer and/or print setting.

9. The information processing device according to claim 1,
wherein the control unit includes a fourth setting system configured to set, in accordance with a user input, whether a print execution confirmation dialogue is displayed before print operation is executed when the control unit identified the printer and/or print setting.

10. The information processing device according to claim 1,
wherein the control unit includes a fifth setting system configured to display the printer selection information and/or print setting information in a user-recognizable manner on the display screen.

11. A computer accessible recording medium containing a program executable by a computer, the program causing, when executed, the computer to operate as an information processing device, the computer being provided with a display device having a display screen and connected with one or more printers,
the information processing device comprising:
a display controller configured to display a data display window on the display screen, printable data files being displayed on the display screen and/or inside the data display window;
at least one decision area defined within the display screen;
a user interface acquiring a drag and drop operation to any one of the printable data files;
a dropped position detecting unit configured to detect a drop position of the printable data file to which the drag and drop operation is applied;
a storage configured to store, in association with the at least one decision area, printer selection information identifying one of the connected printers to be used for printing and/or print setting information representing print settings to be used for printing;
a judging unit configured to judge whether the dropped position is within the at least one decision area;
a control unit configured to identify a printer to be used for executing print operation based on the printer selection information corresponding to the at least one decision area and/or print setting to be used for executing the print operation based on the print setting information if the judging unit judges the dropped position is within the at least one decision area, print data being generated in accordance with the printer and/or print setting identified by the control unit.

12. A method of controlling an information processing device to which one or more printers are connected, the information processing device including a display device having a display screen, the method comprising the steps of:
displaying a data display window on the display screen, printable data files being displayed on the display screen and/or inside the data display window;
defining at least one decision area within the display screen;
acquiring a drag and drop operation to any one of the printable data files;
detecting unit configured to detect a drop position of the printable data file to which the drag and drop operation is applied;
storing, in association with the at least one decision area, printer selection information identifying one of the connected printers to be used for printing and/or print setting information representing print settings to be used for printing;
judging whether the dropped position is within the at least one decision area;
identifying a printer to be used for executing print operation based on the printer selection information corresponding to the at least one decision area and/or print setting to be used for executing the print operation based on the print setting information if the judging unit judges the dropped position is within the at least one decision area, print data being generated in accordance with the printer and/or print setting identified by the control unit.
